(19) United States
(12) Patent Application Publication
(10) Pub. No.: US 2015/0052973 A1
(43) Pub. Date: Feb. 26, 2015

(54) GAS SENSOR

(71) Applicant: NGK SPARK PLUG CO., LTD., Nagoya-shi (JP)

(72) Inventors: Takashi NAKASHIMA, Inuyama-shi (JP); Kensuke MIZUTANI, Komaki-shi (JP); Makoto HIRASAWA, Kasugai-shi (JP)

(73) Assignee: NGK SPARK PLUG CO., LTD., Nagoya-shi (JP)

(21) Appl. No.: 14/458,504

(22) Filed: Aug. 13, 2014

(30) Foreign Application Priority Data
Aug. 20, 2013 (JP) 2013-170541

(51) Int. Cl. G01D 11/24

(52) U.S. Cl. CPC G01D 11/245
USPC 73/23.2

(57) ABSTRACT

A protector (42) of a full-range-air-fuel-ratio sensor (2) is made of a material having an Ni content of 30.0 to 35.0 wt %, a Cr content of 19.0 to 23.0 wt %, an Al content of 0.15 to 0.60 wt %, and containing at least Fe as balance. The material of the protector may further contain Ti in an amount of 0.15 to 0.60 wt %.

### BACKGROUND OF THE INVENTION

1. Field of the Invention

The present invention relates to a gas sensor having a gas detection element for detecting a specific gas present in an object gas, a metallic shell which surrounds the gas detection element, and a protector which is fixed to the metallic shell and which covers the detection portion of the gas detection element.

2. Description of the Related Art

A known gas sensor has a gas detection element for detecting a specific gas present in an object gas, a metallic shell which surrounds the gas detection element, and a protector which is fixed to the metallic shell and which covers the detection portion of the gas detection element.

Such a gas sensor is employed for detecting a specific gas present in an object gas such as an exhaust gas, and examples of the gas sensor include an oxygen sensor, an NOx sensor, and an HC sensor.

In one such gas sensor, the metallic shell is made of SUS 430, and the protector is made of SUS 310S (Patent Document 1). In the gas sensor, the protector is welded to the front end of the metallic shell.

[Patent Document 1] Japanese Patent Application Laid-Open (kokai) No. 2006-208165

3. Problems to be Solved by the Invention

However, the protector of the aforementioned gas sensor undergoes oxidation loss (i.e., a decrease in weight caused by oxidation) at high temperature, and in some cases the protector may become detached from the metallic shell. Also, the impact resistance of the protector may decrease due to σ (sigma) phase embrittlement. See, as to σ phase embrittlement generally, U.S. Pat. No. 5,298,093 and U.S. Publication No. US 2005/0158201 incorporated herein by reference in their entirety.

Thus, when the joint portion of the protector with the metallic shell undergoes oxidation loss, the protector may detach from the metallic shell. In other words, the protector of the aforementioned gas sensor may have insufficient oxidation resistance at high temperature.

Also, when σ phase embrittlement occurs in the joint portion of the protector with the metallic shell, impact resistance decreases, whereby the protector may detach from the metallic shell upon external impact, which is problematic. In other words, in the aforementioned gas sensor, σ phase embrittlement may reduce the impact resistance of the protector.

### SUMMARY OF THE INVENTION

The present invention has been made in view of the foregoing, and an object thereof is to provide a gas sensor which exhibits excellent oxidation resistance at high temperature, and having a protector which does not exhibit a reduction in impact resistance which would otherwise be caused by σ phase embrittlement.

The aforementioned object has been achieved by providing (1) a gas sensor comprising a gas detection element for detecting a specific gas present in an object gas, which extends in an axial direction from a rear end side to a forward end side of the gas sensor and which has, in a forward end portion thereof, a detection portion so as to contact the object gas; a metallic shell which surrounds the gas detection element such that the detection portion protrudes from the front end of the metallic shell; and a protector which is fixed to the metallic shell and which covers the detection portion of the gas detection element, wherein the protector is made of a material containing Ni in an amount of 30.0 to 35.0 wt %, Cr in an amount of 19.0 to 23.0 wt %, Al in an amount of 0.15 to 0.60 wt %, and at least Fe as balance.

The protector has an Ni content of 30.0 to 35.0 wt %, a Cr content of 19.0 to 23.0 wt %, and an Al content of 0.15 to 0.60 wt %, the balance being at least Fe.

As shown in the below-described comparative measurement results (Table 1), the material forming the protector has a higher resistance to oxidation loss at high temperature (e.g., 650 to 900° C.) as compared with SUS 310S. Incorporating Al into the material suppresses the growth of oxide, thereby preventing removal of oxide resulting in weight loss. Thus, the above material exhibits excellent oxidation resistance.

As also shown in the below-described comparative measurement results (Table 1), the above material has a higher resistance to σ phase embrittlement at high temperature (650° C.) as compared with SUS 310S. In addition, as shown in the below-described comparative measurement results (Table 1), the above material exhibits the same mechanical strength as that of SUS 310S at high temperature (800 to 1,000° C.).

The protector made of the aforementioned material has higher resistance to oxidation loss at high temperature, as compared with a conventional protector made of SUS 310S. Thus, the protector of the present invention resists detachment from the metallic shell, which would otherwise be caused by oxidation loss. That is, the protector exhibits excellent oxidation resistance at high temperature.

Also, the protector employed in the gas sensor of the present invention resists σ phase embrittlement at high temperature, as compared with a conventional protector made of SUS 310S. As a result, detachment of the protector from the metallic shell, which would otherwise be caused by σ phase embrittlement, can be suppressed. That is, a reduction in impact resistance of the protector can be prevented, which would otherwise be caused by σ phase embrittlement at high temperature.

Furthermore, the protector employed in the gas sensor of the present invention has the same mechanical strength as that of a conventional protector made of SUS 310S. Therefore, the protector of the present invention can replace a conventional protector.

Thus, according to the gas sensor of the present invention, the protector exhibits excellent oxidation resistance at high temperature, and a reduction in impact resistance of the protector, which would otherwise be caused by σ phase embrittlement, can be suppressed.

Meanwhile, the total amount of the materials forming the protector of the present invention is defined as 100 wt %.

In a preferred embodiment (2) of the gas sensor (1) above, the material of the protector further contains Ti.

When the material forming the protector further contains Ti, the mechanical strength of the protector at high temperature can be further enhanced. Thus, the protector made of a material further containing Ti has high mechanical strength at high temperature.

Thus, according to the gas sensor of the present invention, by virtue of the presence of a protector having high mechanical strength at high temperature, breakage of the protector due to a reduction in mechanical strength at high temperature can be prevented.

### EFFECTS OF THE INVENTION

The gas sensor of the present invention has a protector exhibiting excellent oxidation resistance at high temperature, such that a reduction in impact resistance of the protector, which would otherwise be caused by σ phase embrittlement, is suppressed.

### BRIEF DESCRIPTION OF THE DRAWINGS

FIG. 1 is a cross-section showing an overall structure of a full-range-air-fuel-ratio sensor of a first embodiment.

FIG. 2 is a cross-section showing an overall structure of an oxygen sensor of a second embodiment.

### DETAILED DESCRIPTION OF THE PREFERRED EMBODIMENTS

Next, embodiments according to the present invention will be described with reference to the drawings. However, the present invention should not be construed as being limited thereto.

### 1. First Embodiment

### 1-1. Overall Structure

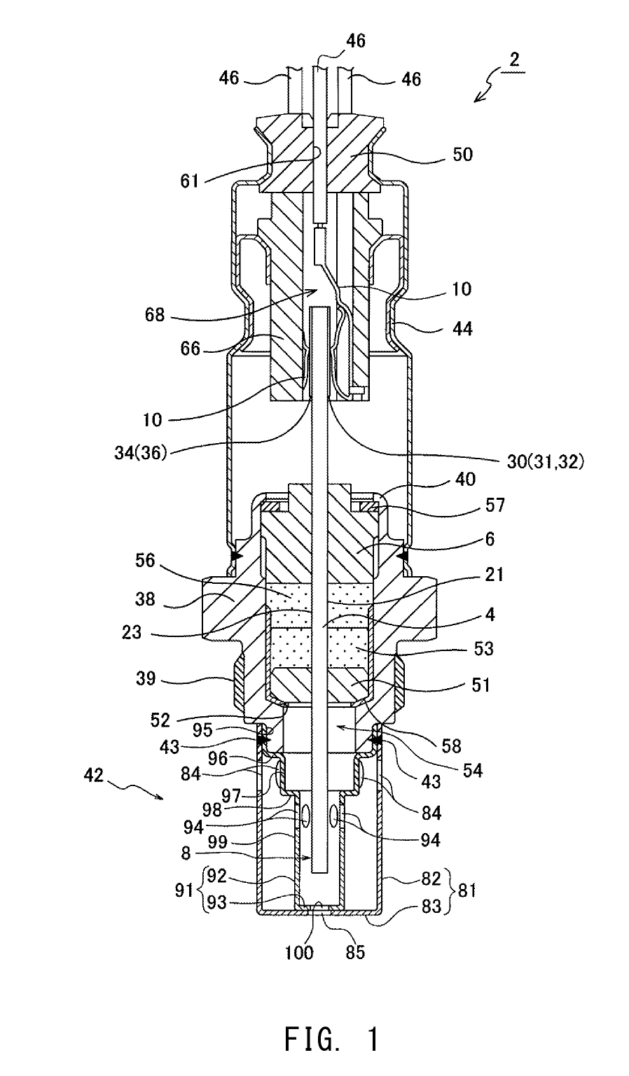

FIG. 1 is a cross-section showing an overall structure of a full-range-air-fuel-ratio sensor 2 (hereinafter also referred to as an “air-fuel-ratio sensor 2”) of the first embodiment.

The air-fuel-ratio sensor 2 is a type of gas sensor and is installed in, for example, an exhaust pipe of an internal combustion engine for feedback-control of the air-fuel ratio of an automobile or an internal combustion engine. The air-fuel-ratio sensor 2 has a gas detection element that can detect oxygen (i.e., a specific gas) present in a measurement object exhaust gas (i.e., an object gas).

The air-fuel-ratio sensor 2 has a housing 38, a gas detection element 4, a protector 42, a ceramic sleeve 6, an insulating contact member 66, and five connection terminals 10.

The housing 38 is a tubular member having, on the outer surface thereof, a screw portion 39 for connection to an exhaust pipe, and is made of SUS 430. The gas detection element 4 is a plate-like element extending in an axial direction (the longitudinal direction of the air-fuel-ratio sensor 2; the up-to-down direction in FIG. 1). The protector 42 is a bottomed tubular member which is fixed to the forward end side periphery of the housing 38 and covers the forward end portion of the gas detection element 4. The ceramic sleeve 6 is a tubular member which surrounds the gas detection element 4. The insulating contact member 66 is disposed such that the wall of a contact insertion hole 68, which penetrates in the axial direction, surrounds a rear end portion of the gas detection element 4. The five connection terminals 10 are metallic members and are disposed between the gas detection element 4 and the insulating contact member 66.

The gas detection element 4 is a plate-like element extending in the axial direction. A detection portion 8 covered with a protective layer is provided on the forward end side (lower in FIG. 1), so as to contact an object gas. On the rear end side (upper in FIG. 1), electrode terminal portions 30, 31, 32, 34, and 36 are provided on a first plate surface 21 and a second plate surface 23, respectively, having a mirror relationship among the outer surfaces. When the detection portion 8 comes in contact with a specific gas, the gas detection element 4 outputs a sensor output signal in response to the specific gas concentration or other properties via the electrode terminal portions.

When disposed between the gas detection element 4 and the insulating contact member 66, the connection terminals 10 are electrically connected to respective electrode terminal portions 30, 31, 32, 34, and 36 of the gas detection element 4. Also, the connection terminal 10 is electrically connected to lead wires 46 disposed from the outside to the inside of the sensor, to thereby form current paths between the electrode terminal portion 30, 31, 32, 34, and 36, and external devices connected to the lead wires 46.

The housing 38 is a generally tubular member which has a through hole 54 penetrating in the axial direction and a shelf portion 52 protruding toward the inside of the through hole 54. The housing 38 holds the gas detection element 4 such that the detection portion 8 is exposed from the forward end side of the through hole 54 and the electrode terminal portions 30, 31, 32, 34, and 36 are exposed from the rear end side of the through hole 54. The shelf portion 52 is an inwardly tapered surface which is slanted with respect to a plane orthogonal to the axial direction.

In the through hole 54 of the housing 38, a ring-form ceramic holder 51, powder-charged layers 53, 56 (hereinafter referred to as talc rings 53, 56), and the aforementioned ceramic sleeve 6 are stacked in this order from the forward end side to the rear end side, so as to surround the gas detection element 4.

A crimp packing 57 is provided between the ceramic sleeve 6 and the rear end portion 40 of the housing 38. The rear end portion 40 of the housing 38 is crimped by mediation of the crimp packing 57 such that the ceramic sleeve 6 is pressed to the forward end side.

A metallic holder 58 is disposed between the ceramic holder 51 and the shelf portion 52 of the housing 38 so as to maintain air-tightness. The metallic holder 58 also holds the talc 53 and the ceramic holder 51.

That is, the housing 38 surrounds the gas detection element 4 such that the detection portion 8 is exposed from the front end of the housing 38.

The gas detection element 4 is a plate-like element having a rectangular axial cross-section. In the gas detection element 4, a plate-like element portion extending in the axial direction is stacked on a plate-like heater extending in the axial direction. Notably, since the gas detection element 4 serving as the air-fuel-ratio sensor 2 is a known element, a detailed description including its internal structure and the like is omitted.

As shown in FIG. 1, in the gas detection element 4, the detection portion 8 disposed on the forward end side (lower in FIG. 1) protrudes from the front end of the housing 38, and the electrode terminal portions 30, 31, 32, 34, and 36 disposed on the rear end side protrude from the rear end of the housing 38. In this state, the detection portion 8 and the electrode terminal portions 30, 31, 32, 34, and 36 are fixed in the housing 38.

An outer tube 44 is fixed to the periphery of the housing 38 on the rear end side. An opening of the outer tube 44 on the rear end side (upper in FIG. 1) is provided with a grommet 50 in which a lead line insertion hole 61 has been formed. Five lead lines 46 (three lines are shown in FIG. 1) electrically connected to the respective electrode terminal portions 30, 31, 32, 34, and 36 are inserted into the hole 61.

The insulating contact member 66 is attached to the gas detection element 4 on the rear end side (upper in FIG. 1), the detecting element protruding through the rear end portion 40 of the housing 38. The insulating contact member 66 surrounds the electrode terminal portions 30, 31, 32, 34, and 36 which are formed on the surface of the gas detection element 4 in the rear end side thereof.

### 1-2. Structure of Protector

The protector 42 is a bottomed tubular member provided with a plurality of gas passage openings. The protector 42 is fixed to the periphery of the housing 38 on the forward end side (lower in FIG. 1) so as to cover the protruded portion of the gas detection element 4. A joint portion 43 between the protector 42 and the housing 38 is formed by welding or a similar technique.

The protector 42 has a dual tubular structure including a bottomed outer tubular member 81, and a bottomed inner tubular member 91 disposed inside the outer tubular member 81.

The outer tubular member 81 has a tubular outer side wall 82, and an outer bottom wall 83 provided on the forward end side of the outer side wall 82. The outer side wall 82 of the outer tubular member 81 is provided with a plurality of (8 in this embodiment) outer wall gas passage openings 84.

The inner tubular member 91 has a tubular inner side wall 92 surrounded by the outer side wall 82, and an inner bottom wall 93 disposed on the forward end side of the inner side wall 92. The inner side wall 92 of the inner tubular member 91 is provided with a plurality of (8 in this embodiment) inner wall gas passage openings 94.

The inner side wall 92 includes, in an axial direction from a rear end side to a forward end side of the gas sensor, a fixation portion 95, a fixation step 96, a maximum inner diameter portion 97, a size variation step 98, and a minimum inner diameter portion 99.

The size variation step 98 is formed as a plate orthogonal to the axial direction for modifying the inner diameter of the inner side wall 92 in a cross-section orthogonal to the axial direction. The maximum inner diameter portion 97 is formed such that the inner diameter of a cross-section orthogonal to the axial direction is equal to the maximum inner diameter of the size variation step 98. The minimum inner diameter portion 99 is formed such that the inner diameter of a cross-section orthogonal to the axial direction is equal to the minimum inner diameter of the size variation step 98.

The minimum inner diameter portion 99 of the inner side wall 92 is provided with the plurality of inner wall gas passage openings 94 along the periphery thereof.

The inner tubular member 91 is provided with an inner bottom wall gas passage opening 100 for discharging the object gas from the inside of the inner tubular member 91 via the inner bottom wall 93.

Meanwhile, the outer side wall 82 is provided with the plurality of outer wall gas passage openings 84 along the periphery thereof, at positions corresponding to the maximum inner diameter portion 97 of the inner side wall 92. That is, the outer wall gas passage openings 84 are located at an axial position different from that of the inner wall gas passage openings 94.

Meanwhile, the outer tubular member 81 is provided with an outer bottom wall gas passage opening 85 for discharging the object gas from the inside of the outer tubular member 81 via the outer bottom wall 83.

The outer tubular member 81 and the inner tubular member 91 of the protector 42 are each made of a material (alloy) having an atomic composition 32Ni-20Cr—Ti—Al. More specifically, each of the outer tubular member 81 and the inner tubular member 91 of the protector 42 is formed of a material which has an Ni content of 30.0 to 35.0 wt %, a Cr content of 19.0 to 23.0 wt %, an Al content of 0.15 to 0.60 wt %, and a Ti content of 0.15 to 0.60 wt %, the balance being at least Fe.

Meanwhile, the total amount of the materials forming the protector 42 is 100 wt %. The balance may contain, in addition to Fe, an unavoidable impurity (C, Si, Mn, P, or S). The total amount of such unavoidable impurities is preferably as small as possible.

### 1-3. Comparative Assay of the Material of the Protector

The material of the protector 42 (the outer tubular member 81 and the inner tubular member 91) of the present embodiment was evaluated and compared with a conventional material, SUS 310S.

The protector materials were evaluated in terms of oxidation resistance (oxidation loss), σ phase embrittlement, and strength at high temperature. SUS 310S having a non-ferrous atomic composition of 20Ni-25Cr was evaluated.

In the measurement of oxidation resistance (oxidation loss), each material sample was maintained at 1,000° C. for 30 minutes and then cooled at ambient temperature (25° C.) for 10 minutes. The cycle was repeatedly performed 200 times in total. Thereafter, the oxidation loss of the sample was measured.

In the evaluation of σ phase embrittlement, each material sample was maintained at 650° C., and occurrence of σ phase embrittlement was examined.

In the measurement of high-temperature strength, tensile strength of each sample was measured at 800° C., 900° C., and 1,000° C.

Table 1 below shows the results of the comparative measurements. In Table 1, the material of the present embodiment is denoted by “EXAMPLE,” and SUS 310S is denoted by “COMP. EX.”

TABLE 1

| | OXIDATION | | | | |
|---|---|---|---|---|---|
| | RESISTANCE | | HIGH-TEMP. TENSILE | | |
| | (OXIDATION LOSS) | σ PHASE | STRENGTH [MPa] | | |
| | [mg/cm²] | EMBRITTLEMENT | 800° C. | 900° C. | 1000° C. |
| EXAMPLE | −0.4 | HIGHLY RESISTANT | 186 | 106 | 59 |
| | | AND HARDLY | | | |
| | | OBSERVED | | | |
| COMP. EX. | −68.0 | PRESENT | 182 | 110 | 63 |

As shown in Table 1, the material forming the protector 42 of the present embodiment exhibited an oxidation loss remarkably smaller than that of SUS 310S. Thus, the material of the invention was found to have excellent oxidation resistance.

Further, σ phase embrittlement was hardly observed in the material forming the protector 42 of the present embodiment, but was present in SUS 310S. Thus, the material forming the protector 42 of the present embodiment was found to have a higher resistance to σ phase embrittlement, as compared with SUS 310S.

Regarding mechanical strength at high temperature, the material forming the protector 42 of the present embodiment was found to have almost the same tensile strength as that of SUS 310S at all measurement temperatures. Therefore, the protector 42 of the present embodiment can be used in place of a conventional protector made of SUS 310S.

### 1-4. Effects

As described above, in the full-range-air-fuel-ratio sensor 2 of the present embodiment, the protector 42 is formed of a material which has an Ni content of 30.0 to 35.0 wt %, a Cr content of 19.0 to 23.0 wt %, an Al content of 0.15 to 0.60 wt %, and a Ti content of 0.15 to 0.60 wt %, the balance being at least Fe.

The aforementioned comparative test reveals that the protector 42 has higher resistance to oxidation loss at high temperature, as compared with a conventional protector made of SUS 310S. As a result, detachment of the protector 42 from the housing 38 can be prevented, which would otherwise be caused by oxidation loss. In other words, the protector 42 exhibits excellent oxidation resistance at high temperature.

The aforementioned comparative test also reveals that the protector 42 has higher resistance to σ phase embrittlement at high temperature, as compared with a conventional protector made of SUS 310S. As a result, detachment of the protector 42 from the housing 38 can be prevented, which would otherwise be caused by σ phase embrittlement. In other words, a reduction in impact resistance of the protector 42, which would otherwise be caused by σ phase embrittlement at high temperature, can be suppressed.

Furthermore, the aforementioned comparative test also reveals that the protector 42 has almost the same tensile strength as that of a conventional protector made of SUS 310S, whereby the protector 42 can be used in place of the conventional protector.

Thus, according to the full-range-air-fuel-ratio sensor 2 of the present embodiment, the protector 42 exhibits excellent oxidation resistance at high temperature, and a reduction in impact resistance of the protector 42, which would otherwise be caused by a phase embrittlement, can be suppressed.

The protector 42 of the embodiment also contains Ti. When the material of the protector 42 contains Ti, mechanical strength of the protector 42 at high temperature can be further enhanced, as compared to the case where the material contains no Ti. Thus, the protector 42 containing Ti exhibits excellent mechanical strength at high temperature.

Thus, since the full-range-air-fuel-ratio sensor 2 of the present embodiment has the protector 42 having excellent mechanical strength at high temperature, breakage of the protector 42 can be prevented, which would otherwise be caused by a reduction in mechanical strength at high temperature.

### 1-5. Corresponding Structure

Structure in the above embodiment corresponding to the invention will next be described.

The full-range-air-fuel-ratio sensor 2 (i.e., the air-fuel-ratio sensor 2) corresponds to an example of the gas sensor of the invention. The housing 38 is an example of the metallic shell of the invention. The exhaust gas corresponds to an example of the object gas of the invention. Oxygen corresponds to an example of the specific gas of the invention.

### 3. Other Embodiments

Although an embodiment of the present invention has been described above, the embodiment as well as the invention should not be construed as being limited thereto. Various other embodiments are also possible which can achieve the object of the invention.

For example, the protector described in the above embodiment has a dual tubular structure including a bottomed outer tubular member and a bottomed inner tubular member. However, no particular limitation is imposed on the form of the protector, and a protector may be employed having a single structure including only an outer tubular member. Alternatively, a protector may be employed having a triplet structure including an outer tubular member, an internal tubular member, and an inner tubular member.

The shape of the gas detection element is not limited to the aforementioned plate-like shape, and the gas detection element may assume a bottomed tube.

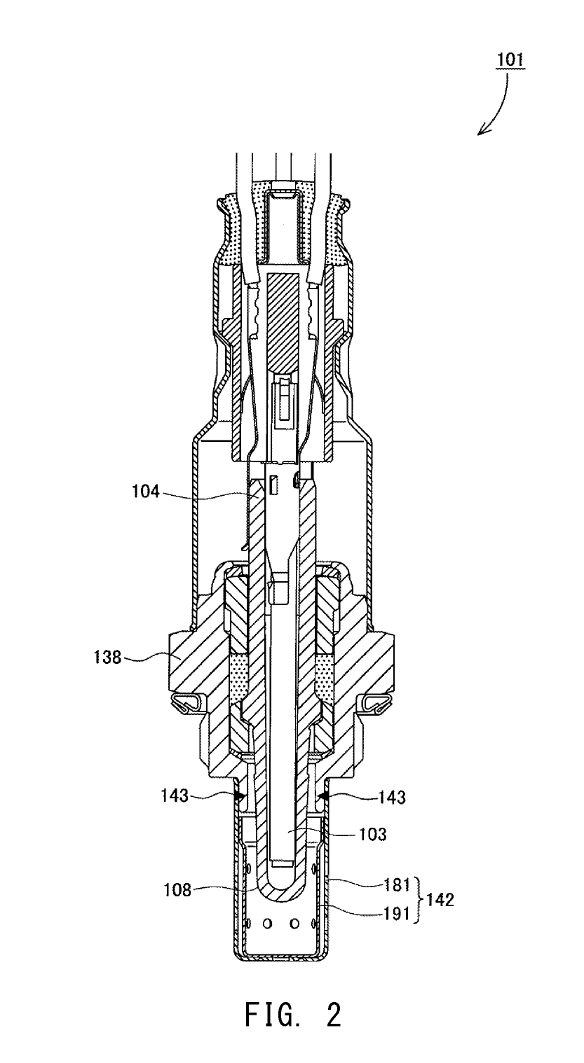

Thus, a second embodiment will be briefly described in reference to FIG. 2. The second embodiment is a gas sensor 101 (i.e., an oxygen sensor 101) having a bottomed tubular detection element 104. Notably, the oxygen sensor 101 is used to detect oxygen present in, for example, an exhaust gas of an internal combustion engine.

FIG. 2 is a cross-section showing an overall structure of the gas sensor 101 (i.e., the oxygen sensor 101).

As shown in FIG. 2, the oxygen sensor 101 has a bottomed tubular detection element 104, a housing 138, and a protector 142.

The tubular detection element 104 is made of a solid electrolyte predominantly containing zirconia and extends in the axial direction. The forward end (lower in FIG. 2) thereof is closed to form a bottomed tubular element. The tubular detection element 104 has, on the forward end side, a detection portion 108 for contacting the object gas. When heated by means of a rod-shape ceramic heater 103 disposed therein, the tubular detection element 104 is activated to allow detection of oxygen (specific gas).

The housing 138 surrounds the tubular detection element 104 such that the detection portion 108 is exposed from the front end of the housing 138, and accommodates the internal structure of the oxygen sensor 101. Also, the housing 138 serves as fixation means for fixing the oxygen sensor 101 to a fixation portion of an exhaust pipe or the like.

The protector 142 is fixed to the housing 138 such that it covers the detection portion 108 of the tubular detection element 104. The protector 142 has a dual structure including a bottomed outer tubular member 181, and a bottomed inner tubular member 191 disposed inside the outer tubular member 181. A joint portion 143 between the protector 142 and the housing 138 is formed by welding or a similar technique.

The outer tubular member 181 and the inner tubular member 191 of the protector 142 are made of the same material as employed in the protector 42 of the first embodiment.

Thus, similar to the full-range-air-fuel-ratio sensor 2 of the first embodiment, the protector 142 of the oxygen sensor 101 exhibits excellent oxidation resistance at high temperature, and a reduction in impact resistance of the protector 142, which would otherwise be caused by σ phase embrittlement, can be suppressed.

Structure in the second embodiment corresponding to the invention will next be described.

The oxygen sensor 101 corresponds to an example of the gas sensor of the invention. The tubular detection element 104 corresponds to an example of the gas detection element of the invention. The housing 138 corresponds to an example of the metallic shell of the invention. The exhaust gas corresponds to an example of the object gas of the invention. Oxygen corresponds to an example of the specific gas of the invention.

### DESCRIPTION OF REFERENCE NUMERALS

Reference numerals used to identify various features in the drawings include the following.
2: full-range-air-fuel-ratio sensor (air-fuel-ratio sensor)
4: gas detection element
8: detection portion
38: housing
42: protector
43: joint portion
81: outer tubular member
91: inner tubular member
101: gas sensor (oxygen sensor)
104: tubular detection element
108: detection portion
138: housing
142: protector
143: joint portion
181: outer tubular member
191: inner tubular member

The invention has been described in detail with reference to the above embodiments. However, the invention should not be construed as being limited thereto. It should further be apparent to those skilled in the art that various changes in form and detail of the invention as shown and described above may be made. It is intended that such changes be included within the spirit and scope of the claims appended hereto.

This application claims priority from Japanese Patent Application No. 2013-170541 filed Aug. 20, 2013, incorporated herein by reference in its entirety.

What is claimed is:

1. A gas sensor comprising
a gas detection element for detecting a specific gas present in an object gas, which extends in an axial direction from a rear end side to a forward end side of the gas sensor and which has, in a forward end portion thereof, a detection portion so as to contact the object gas;
a metallic shell which surrounds the gas detection element such that the detection portion protrudes from the front end of the metallic shell; and
a protector which is fixed to the metallic shell and which covers the detection portion of the gas detection element,
wherein the protector is made of a material containing Ni in an amount of 30.0 to 35.0 wt %, Cr in an amount of 19.0 to 23.0 wt %, Al in an amount of 0.15 to 0.60 wt %, and at least Fe as balance.

2. A gas sensor as claimed in claim 1, wherein the material of the protector further contains Ti.
